(19) United States
(12) Patent Application Publication
(10) Pub. No.: US 2024/0037012 A1
(43) Pub. Date: Feb. 1, 2024

(54) COMPUTER-IMPLEMENTED METHOD FOR VERIFYING A SOFTWARE COMPONENT OF AN AUTOMATED DRIVING FUNCTION

(71) Applicant: Robert Bosch GmbH, Stuttgart (DE)

(72) Inventor: Lukas Koenig, Grossbottwar (DE)

(21) Appl. No.: 18/349,516

(22) Filed: Jul. 10, 2023

(30) Foreign Application Priority Data
Jul. 26, 2022 (DE) 10 2022 207 612.5

(51) Int. Cl. G06F 11/36

(52) U.S. Cl. CPC G06F 11/3608

(57) ABSTRACT

A computer-implemented method for verifying a software component of an automated driving function. The method includes: translating the native program code into a model checker representation of the software component to be verified and analyzing the model checker representation of the software component to be verified using a model checking method. The native program code of the software component to be verified is limited to a set of operations of the programming language used that are defined as permissible. To do this, the native program code is converted into a finite automaton, the states and state transitions of which can be uniquely assigned to the code structure of the native program code. The model checker representation is generated based on the finite automaton such that the code structure of the native program code is substantially retained when the native program code is translated into the model checker representation.

### CROSS REFERENCE

The present application claims the benefit under 35 U.S.C. § 119 of German Patent Application No. DE 10 2022 207 612.5 filed on Jul. 26, 2022, which is expressly incorporated herein by reference in its entirety.

### BACKGROUND INFORMATION

The present invention relates to a computer-implemented method for verifying a software component of an automated driving function, in which the native program code of the software component to be verified is limited to a set of operations of the programming language used that are defined as permissible. A prerequisite for an operation to be defined as permissible in the context of the present invention is that this operation can be described as a finite automaton.

A verification method of the type described here comprises the following steps:
a. translating the native program code into a model checker representation of the software component to be verified and
b. analyzing the model checker representation of the software component to be verified using a model checking method.

As part of the industrial process for developing software components of an automated driving function, such as action planners, fusion algorithms, and other control modules, the correctness of the implementation needs to be checked. Generally speaking, this check is currently test-based; for example, methods such as simulation-based testing or replay hardware-in-the-loop (HIL) solutions are used. However, as a rule, test-based methods do not guarantee that errors are discovered or that the tested software component always provides error-free results in respect of predefined requirements and boundary conditions.

The scientific literature describes techniques and tools for model checking and probabilistic model checking. A model checker checks all the configuration options for software or a model of the software against a mathematically precisely formulated requirement. In this process, a check is performed as to whether all the possible configurations of the software meet this requirement. This can provide formal mathematical proof of whether the software or the model of the software is error-free in relation to the formulated requirement. At this juncture, reference is made to Spin (http://spinroot.com/spin/whatispin.html) and NuSMV (http://nusmv.fbk.eu/) as examples of model checking tools.

To apply the conventional model checking tools, the native program code of the software component to be verified needs to be translated into a model checker representation which has the structure of a finite automaton. In view of the scope and complexity of software components of an automated driving function, this translation should as far as possible take place automatically.

Methods for automatically mining finite automata that use memory state invariants from native program code are conventional. However, in these methods, the reference to the program structure of the translated native program code is lost or at least heavily obscured.

This has proven problematic in practice and in particular for the industrial process for developing software components. For instance, although a finite automaton mined in this way can be model-checked, it is virtually impossible to attribute any errors discovered in the finite automaton to specific operations or instructions of the native program code, and therefore the causes of the errors in the native program code cannot be readily eliminated.

### SUMMARY

In a computer-implemented method according to an example embodiment of the present invention for verifying a software component of an automated driving function, the native program code is converted into a finite automaton (FA), the states and state transitions of which can be uniquely assigned to the code structure of the native program code, and in that the model checker representation is generated on the basis of this finite automaton such that the code structure of the native program code is substantially retained when the native program code is translated into the model checker representation.

According to the present invention, it has been found that retaining the code structure of the native program code in the model checker representation is an essential prerequisite for a meaningful use of model checking tools for verifying software components for automated driving functions, in particular also as part of the development process. In this way, errors discovered during the model checking can be unequivocally traced back to certain operations or instructions of the native program code and thus can be unequivocally and permanently eliminated.

In view of the size and complexity of the software components of an automated driving function, it has often proven advantageous to convert the native program code into a finite automaton in a plurality of steps. In such a variant of the method according to the present invention, in at least one first step, an intermediate representation of the native program code is generated. This first conversion step is also called mining in the following. To do this, certain selected FA-like program structures in the native program code are automatically detected in order to then automatically assign corresponding FA states and FA state transitions to the detected program structures. The resulting intermediate representation of the native program code has the structure of a finite automaton, which is called the FA segment of the intermediate representation. The remaining parts of the native program code, i.e., all the program structures that have not been converted during the mining, are embedded in the FA segment. They are called code segments of the intermediate representation. Because the native program code is limited to a set of permissible operations of the programming language used, these code segments can then also be converted into FA segments in at least one further conversion step. In any case, all the elements of the native program code to be mined are also contained in the intermediate representation, namely the automatically detected FA-like structures in the form of FA segments, but also more complex structures, such as loops, in the form of code segments.

The mining can, for example, be limited to a single, preselected type of FA-like structure so as to automatically convert only program structures of this type into corresponding FA states and FA state transitions. A plurality of preselected types of FA-like structure can, however, also form the basis for the mining, such that, in this first conversion step, all the program structures of these selected types are automatically detected and converted.

In the simplest case, the mining is reduced to simply mapping program structures of one or more types of the native program code to structures of the intermediate representation.

Gradually converting the native program code into a finite automaton may ensure, in a simple manner, that the states and state transitions of the resulting finite automaton can be uniquely assigned to the code structure of the native program code. Advantageously, this approach is independent of the programming language of the native program code, at least for all standard procedural, object-oriented, and functional programming languages, such as C++, Python, and Java, which are typically used for implementing automated driving functions.

In many cases, the automatic detection and conversion of FA-like structures of the native program code can be improved by optimizing the native program code prior to the conversion into a finite automaton. To do this, compilers can be used, for example, which effectively simplify the program structure of the native program code.

In a particularly advantageous variant of the method according to the present invention, the native program code is analyzed to detect FA-like structures of the “switch case” instruction type. A separate FA state and at least one state transition between FA states are then assigned to each “case” component of a detected “switch case” instruction. A conversion of this kind can produce an intermediate representation of the native program code that has FA segments, which have the structure of the “switch case” instructions, and code segments of “case” components, which are retained during the conversion. In addition, an intermediate representation of this kind can of course also comprise further code segments which trace back to other program structures of the native program code in the form of the “switch case” instructions detected during the mining.

The mining of finite automata on the basis of “switch case” instructions is advantageous in several respects. First of all, a very large number of program functions can be represented in the form of “switch case” instructions and, second of all, it is very simple to assign a “switch case” instruction to FA states and FA state transitions, as will also be described again in the following with reference to an exemplary embodiment.

It is also possible and in some cases expedient to treat the entire native program code of the software component to be verified as a single “case” component of a “switch case” instruction in order to generate a “degenerated” variant of an intermediate representation. To do this, the entire native program code is embedded in a single state of the intermediate representation. This allows for further processing and optimization in the code of the intermediate representation.

### BRIEF DESCRIPTION OF THE DRAWINGS

Advantageous specific embodiments and developments of the present invention are explained in the following with reference to the figures.

FIG. 1 is a block diagram of an advantageous variant 10 of the computer-implemented method according to the present invention for verifying a software component of an automated driving function.

FIG. 2A to 2C illustrate the translation of the native program code of a software component to be verified into a model checker representation as part of the variant of the verification method according to the present invention, as shown in FIG. 1.

### DETAILED DESCRIPTION OF EXAMPLE EMBODIMENTS

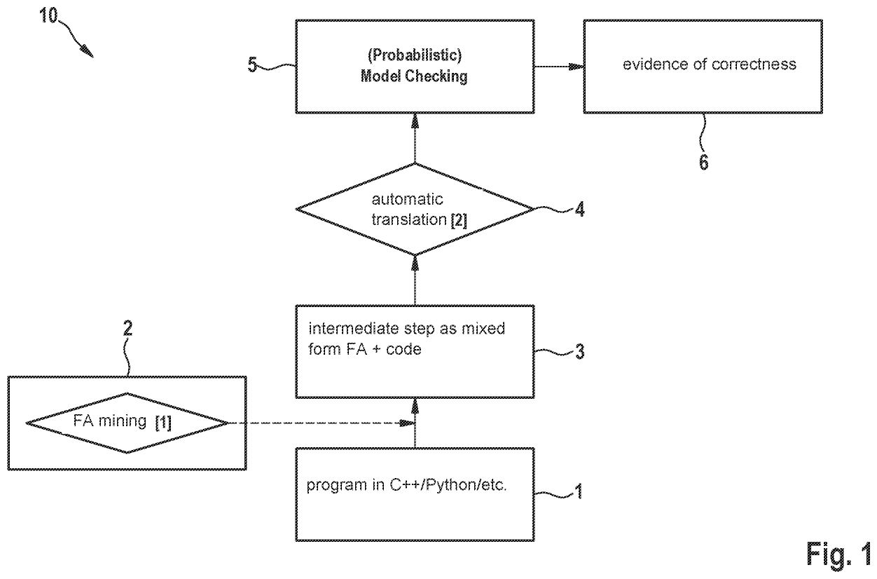

As explained above, the present invention(s) provide measures which make it possible to use model checking to verify software components of an automated driving function, in particular also during the development process. Accordingly, the computer-implemented verification method 10 according to the present invention, as shown in FIG. 1, provides that the native program code 1 of a software component to be verified is first translated into a model checker representation of the software component to be verified and this model checker representation is then analyzed using a model checking method (block 5), in order to provide evidence of the correctness of the software component or to identify errors in the native program code 1 (block 6).

A prerequisite for fully automating the translation of the native program code into a model checker representation is that the native program code only contains operations that can themselves be described as a finite automaton. Therefore, to apply the verification method 10 according to the present invention, it is not necessary to use all the available operations of the relevant programming language when developing the native program code, but only a subset of the available operations. For C++ or Python programs, for this purpose, all the loop/GoTo/recursion structures are dispensed with, for example.

According to the present invention, the native program code is first converted into a finite automaton (FA), the states and state transitions of which can be uniquely assigned to the code structure of the native program code, in order to then generate a model checker representation on the basis of this finite automaton such that the code structure of the native program code is substantially retained when the native program code is translated into the model checker representation.

At this point, it should be noted that, in certain cases, the thus generated finite automaton can already be used as a model checker representation, i.e., as an input for the model checker. In these cases, a further translation step is not required.

In the exemplary embodiment according to FIG. 1, the native program code 1 is converted into a finite automaton in two steps. In the first step, known as mining (block 2), FA-like structures of a certain type are detected in the native program code. Corresponding FA states and FA state transitions are assigned to the automatically detected FA-like program structures, also in an automatic manner. In this process, an intermediate representation 3 of the native program code is generated. This intermediate representation 3 already has the structure of a finite automaton, in which the structure of the native program code is retained, however. The remaining parts of the native program code are embedded in the FA structure of the intermediate representation 3. In a further step 4, these “code segments” of the intermediate representation 3 are then likewise automatically converted into FA segments. In this process, a finite automaton is generated which fully represents the native program code and in which the structure of the native program code is retained. This finite automaton can then either be translated into a model checker representation or be directly used for the model checking in block 5.

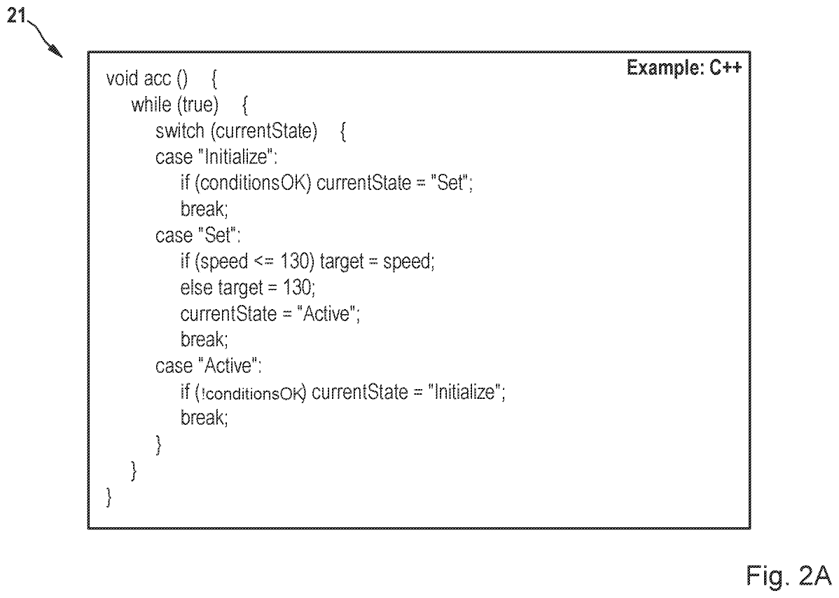

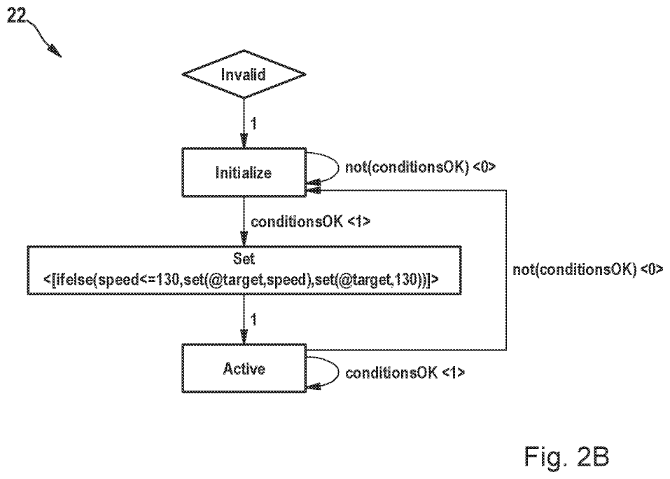

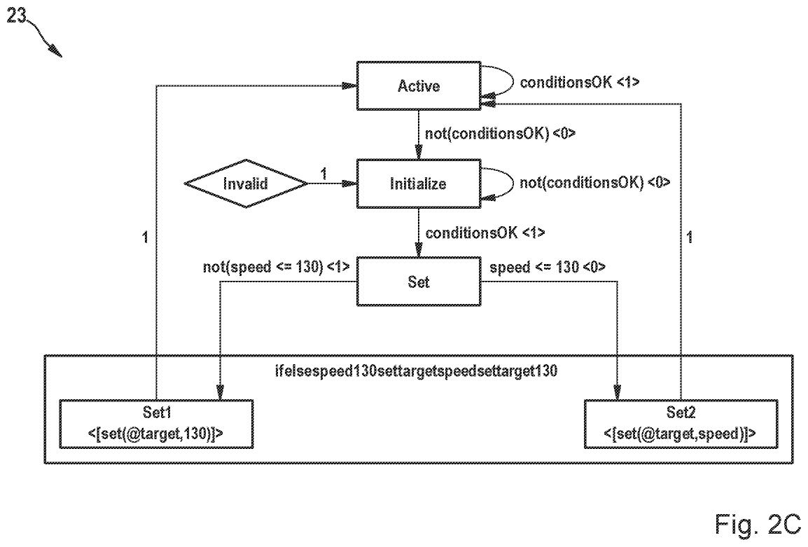

The two-stage conversion of the native program code of a software component to be verified into a finite automaton is explained in greater detail in conjunction with the example shown in FIG. 2A to 2C, in particular the first conversion step 2 of mining.

FIG. 2A shows the following C++ program code 21 of an automated driving function for cruise control, using which the maximum driving speed is to be limited to 130 km/h.

```
Void acc ( ) {
  while (true) {
    switch (currentState) {
    case “Initialize”:
      if (conditionsOK) currentState = “Set”;
      break;
    case “Set”:
      if (speed <= 130) target = speed;
      else target = 130;
      currentState = “Active”;
      break;
    case “Active”:
      if (!conditionsOK) currentState = “Initialize”;
      break;
    }
  }
}
```

The program code 21 substantially consists of a “switch case” instruction having the “switch” variable (currentState) and the three “case” components “Initialize,” “Set,” and “Active”. The state of the automated “cruise control” driving function is continuously monitored using a binary state variable (conditionsOK). If (conditionsOK) is <1>, the automatic cruise control is in a permissible state. (conditionsOK)<0> means that the automatic cruise control is in an impermissible state.

In the event that (currentState)=“Initialize,” the state of the automated “cruise control” driving function is checked. If (conditionsOK) is <1>, the variable (currentState) is set to “Set”.

In the event that (currentState)=“Set,” a check is performed as to whether the current speed, in this case the variable “speed,” is less than or equal to 130 km/h (speed <=130). This is done using a corresponding “if-then-else” instruction. The current speed either is maintained (target=speed) if the current speed is less than or equal to 130 km/h (“if” alternative), or is reduced to 130 km/h (target=130) if the current speed is greater than 130 km/h (“else” alternative). In addition, the variable (currentState) is set to “Active”.

In the event that (currentState)=“Active,” the state of the automated “cruise control” driving function is checked. If (conditionsOK) is <0>, the variable (currentState) is set to “Initialize”.

In the variant of the method according to the present invention described here, FA-like structures in the form of “switch case” instructions are taken as a basis for the mining; that is to say, during the mining, all the “switch case” instructions are detected in order to assign a separate FA state and at least one state transition between FA states to each “case” component.

This assignment or the resulting intermediate representation 22 is shown in FIG. 2B. The intermediate representation 22 comprises FA elements, namely the states “Initialize,” “Set,” and “Active,” and state transitions, which are provided with activation conditions. In addition, however, the intermediate representation 22 also comprises code segments, namely the “if-then-else” instruction in the “Set” state:
if (speed <=130) target=speed;
else target=130;

At this point, however, the code segment is already limited to “FA-like” structures by the mining process. This means that, in this representation, in addition to the usual arithmetic-logic-comparative functions, such as “+,” “&,” “,” only the following operations are performed:
if-then-else,
composition, and
setting of variables.

In a further conversion step, the code segments of the intermediate representation 22 are likewise automatically transferred into FA segments. The resulting finite automaton 23 is shown in FIG. 2C. For this purpose, the “if-then-else” instruction in the “Set” state of the intermediate representation 22 has been split into the two sub-states “Set1” and “Set2”. The sub-state “Set1” corresponds to the “else” alternative, while the sub-state “Set2” reflects the “if” alternative. For instance, in the same way as the intermediate representation 22 provides a state transition between the states “Set” and “Active,” the finite automaton 23 contains a state transition between each sub-state “Set1” or “Set2” and the state “Active”. The finite automaton 23 shown in FIG. 2C forms the basis for a model checker representation of the native program code 21 shown in FIG. 2A, for example for the nuSMV model checker.

Using the above-described automatic mining process, segments of the native program code that are often already large can be converted into an FA-like structure, since, generally speaking, certain requirements for the implementation of FAs in the code need to be met when developing software components. For example, in C++, a representation as a switch case block is standard and is thus implemented in many areas of production. Mixed forms made up of switch case segments, if-else segments, function calls, etc., can form the basis of an automatic mining process of this kind.

Generally speaking, a “switch case” instruction comprises a plurality of “case” components, to each of which a separate FA state and state transitions are then assigned. As already mentioned, the intermediate representation can, however, also be generated in a “degenerated” variant by embedding the entire native program code in a single FA state, which thus retains the same range of functions as the original code. Owing to the flexible “runtime transparent” type of representation, this code can then be further processed in order to be utilized for the model checking. This “simplest case” also provides the option of performing function calls and accordingly also implementing them in the intermediate representation. Typical constructs in imperative, functional, and object-oriented programming languages can thus be implemented without additional measures. In this case, identifying which part of the native code is meant by a function call may be non-trivial, for example in the case of an object-oriented language which permits function overloading by inheritance. In such cases, the native execution mechanism itself, for example the C++ compiler, can be used to perform disambiguation. Furthermore, other optimizations can be built into the mining process which make it possible to process elements that are not present in the target representation or even to specify a state structure that corresponds to the native code better than would be the case if subsequent steps were used.

It is particularly advantageous to use the method according to the present invention in the verification of software components for safety-critical applications having large state spaces which can only be partially covered by testing alone. This relates in particular to driver assistance systems and highly automated driving functions, robots, aircraft controllers, autonomous ships, etc. For instance, using the method according to the present invention, the correctness of individual system components, such as an action planner or another control module, can be checked as early as the design period or during development. The method according to the present invention is characterized by:
Complete provability of requirements, i.e., predefined requirements and boundary conditions.
Applicability to all standard procedural, object-oriented, and functional programming languages, such as C++, Python, Java, etc.
Compatibility with different model checkers. The method generates code which can be processed by different model checkers. As a result, in particular complete proof is possible over high-dimensional state spaces using symbolic model checkers.
Fully automated tooling for continuous integration. The method is fully automated and can thus be integrated in a continuous integration pipeline.
Explainability, i.e., user-friendly human-readable outputs on all intermediate layers for debugging, etc. The entire process, from the native code to the model checker, operates with intermediate steps that correspond to one another in structure. Each step can be performed and tested separately.

What is claimed is:

1. A computer-implemented method for verifying a software component of an automated driving function, wherein native program code of the software component to be verified is limited to a set of operations of a programming language used that are defined as permissible, the method comprising the following steps:
translating the native program code into a model checker representation of the software component to be verified; and
analyzing the model checker representation of the software component to be verified using a model checking method;
wherein the native program code is converted into a finite automaton (FA), states and state transitions of which can be uniquely assigned to a code structure of the native program code, and the model checker representation is generated based on the finite automaton such that the code structure of the native program code is substantially retained when the native program code is translated into the model checker representation.

2. The method as recited in claim 1, wherein, in at least one first step, FA-like structures are detected in the native program code, in that corresponding FA states and FA state transitions are assigned to the FA-like structures, and in that an intermediate representation of the native program code is generated which has the structure of a finite automaton (FA segments), in which remaining parts of the native program code (code segment) are embedded.

3. The method as recited in claim 2, wherein, in at least one further step, at least one code segment of the intermediate representation is converted into FA segments.

4. The method as recited in claim 1, wherein FA-like structures in the form of “switch case” instructions are detected and a separate FA state and at least one state transition between FA states are assigned to each “case” component of a detected “switch case” instruction.

5. The method as recited in claim 4, wherein, based on at least one “switch case” instruction of the native program code, an intermediate representation having the structure of a finite automaton is generated, in which remaining parts of the native program code are embedded.

6. The method as recited in claim 5, wherein at least one “case” component includes native program code, which is retained during the conversion into the intermediate representation.

7. The method as recited in claim 1, wherein the entire native program code of the software component to be verified is assigned to a single FA state.

8. The method as recited in claim 1, wherein the native program code of the software component to be verified is optimized before being converted into a finite automaton in order to simplify the program structure of the native program code.

9. A non-transitory computer-readable medium on which is stored a computer program for verifying a software component of an automated driving function, wherein native program code of the software component to be verified is limited to a set of operations of a programming language used that are defined as permissible, the computer program, when executed by a computer, causing the computer to perform the following steps:
translating the native program code into a model checker representation of the software component to be verified; and
analyzing the model checker representation of the software component to be verified using a model checking method;
wherein the native program code is converted into a finite automaton (FA), states and state transitions of which can be uniquely assigned to a code structure of the native program code, and the model checker representation is generated based on the finite automaton such that the code structure of the native program code is substantially retained when the native program code is translated into the model checker representation.

10. A computer-implemented system for verifying a software component of an automated driving function, wherein native program code of the software component to be verified is limited to a set of operations of a programming language used that are defined as permissible, the system being configured to:
translate the native program code into a model checker representation of the software component to be verified; and
analyze the model checker representation of the software component to be verified using a model checking method;
wherein the native program code is converted into a finite automaton (FA), states and state transitions of which can be uniquely assigned to a code structure of the native program code, and the model checker representation is generated based on the finite automaton such that the code structure of the native program code is substantially retained when the native program code is translated into the model checker representation.
